(19) United States
(12) Patent Application Publication
(10) Pub. No.: US 2019/0077970 A1
(43) Pub. Date: Mar. 14, 2019

(54) NEUTRALIZATION COMPOSITIONS AND METHODS FOR THEIR USE

(71) Applicant: TIAX LLC, Lexington, MA (US)

(72) Inventor: Kevin Beltis, Natick, MA (US)

(21) Appl. No.: 16/037,260

(22) Filed: Jul. 17, 2018

Related U.S. Application Data
(60) Provisional application No. 62/533,160, filed on Jul. 17, 2017.

(51) Int. Cl. C09D 5/02; C09D 129/04; B05D 3/10

(52) U.S. Cl. CPC C09D 5/025; C09D 5/022; C08K 5/50; B05D 3/108; C09D 129/04

(57) ABSTRACT

Provided are processes and compositions for neutralizing a material of interest such as a biological, chemical, or other toxic agent on or from a surface. A method includes applying a neutralization composition to a surface having a material of interest deposited thereon where the composition includes a resin and an active decontaminant, encapsulating the material of interest with the neutralization composition, curing or otherwise solidifying the neutralization composition to form a polymeric coating on the surface, and optionally peeling the coating from the surface. The peeling may remove a portion or all of the material of interest from the surface. The presence of the active decontaminant optionally further neutralizes the material of interest independent of peeling. Also provided are neutralization compositions that may be used in the processes provided herein.

### CROSS REFERENCE TO RELATED APPLICATIONS

This application depends from and claims priority to U.S. Provisional Application No. 62/533,160 filed Jul. 17, 2017, the entire contents of which are incorporated herein by reference.

### STATEMENT OF GOVERNMENT INTEREST

Funding for the present invention was obtained from the Government of the United States by virtue of Contract Nos. F33615-03-M-6381 from the US Air Force and EP-D-06-059 and EP-D-17-013 from the U.S. Environmental Protection Agency (EPA). Thus, the Government of the United States has certain rights in and to the invention claimed herein.

### TECHNICAL FIELD

The present specification generally relates to methods and compositions for neutralization of materials and, more specifically, methods and compositions for neutralization of materials that enable safe decontamination and disposal of the materials.

### BACKGROUND

The possible use of chemical and/or biological warfare agents and/or radiological (i.e. particulate) (CBR) contamination during a military action or terrorist attack presents a continuous threat to U.S. military and civilian personnel. The advances in the biotechnology area and the resulting ease of preparing significant quantities of infectious agents and biological toxins have further increased the threat of dissemination of biological hazards as well as the ongoing potential for other weapons of mass destruction such as chemical and radiological threats.

Anthrax has been identified as one of the most probable biological warfare agent terrorist threats. Typically, anthrax would be disseminated as an aerosol in a terrorist attack. The mortality rate of exposed, untreated individuals is greater than 90% and would be expected to act in 1 to 7 days, with most deaths occurring within 48 hours. Anthrax spores are extremely hardy and can persist in the environment for more than 50 years. Many biological warfare agent decontaminants are not effective against anthrax spores. Moreover, any remaining anthrax spores can present an ongoing threat to individuals, including those assisting with decontamination efforts.

Prior methods for neutralization and mitigation of CBR threats that utilize/require aqueous washdown and present issues with the volume of waste generated and/or the potential for run-off into the environment from the primary hazard location. The run-off creates a potential for secondary contamination (i.e., cross contamination). Accordingly, there is a need for nonhazardous compositions that are effective in decontaminating chemical and biological warfare agents while being safe for disposal and methods for their use.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

Methods of neutralizing one or more materials of interest on a surface are provided. A method of neutralizing a material of interest may include applying a neutralization composition to a surface having the material of interest disposed thereon, encapsulating the material of interest with the neutralization composition effective to neutralize the material of interest, curing the neutralization composition on the surface thereby forming a polymeric coating on the surface, and optionally peeling the polymeric coating from the surface effective to remove some or all of the material of interest from the surface. The neutralization composition optionally includes a vinyl resin, optionally polyvinyl alcohol, and an active decontaminant. A neutralization composition may include a vinyl resin, and an active decontaminant. The active decontaminant may be or include tetrakishydroxymethyl phosphonium sulfate (THPS).

Optionally, a method of neutralizing a biological agent may include spraying a neutralization composition including a resin and an active decontaminant onto a surface having the material of interest disposed thereon. The method further includes encapsulating the material of interest with the neutralization composition effective to neutralize the biological agent and curing the neutralization composition on the surface, thereby forming a polymeric coating on the surface. The method may also include peeling the polymeric coating from the surface effective to remove the biological agent from the surface. Peeling the polymeric coating from the hard, non-porous surface is optionally effective to completely remove the polymeric coating from the surface.

Also provided are compositions that may be used to neutralize a material of interest such as a biological, chemical, or other toxic or infectious agent. A neutralization composition optionally includes one or more resins and optionally one or more active decontaminants. A resin is optionally present in an aqueous or non-aqueous solvent that allows the one or more active decontaminants to effectively contact the material of interest and alter one or more physical, chemical, or functional characteristics of the material of interest. A resin is optionally a polymerizable material, or a polymerized material that may form a substantially solid polymeric material upon curing or drying. The resulting polymeric material optionally has suitable flexibility and robust structure so as to be peelable from the surface absent cracking, tearing, fracturing, or other such that the polymeric material may be removed from a surface in one piece and thereby reducing the chance of unwanted spread of a material of interest.

These and additional features provided by the present disclosure will be more fully understood in view of the following detailed description in conjunction with the drawings, abstract, and claims provided.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a peelable polymeric film formed from a neutralization composition being removed from a contaminated surface according to one or more embodiments shown and described herein; and

FIG. 2 depicts a polymerized neutralization composition and an exemplary use as a sampling device according to one or more embodiments shown and described herein.

### DETAILED DESCRIPTION

The following description of particular embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Provided are neutralization compositions that include a polymerizable resin and an active decontamination agent. When the neutralization composition is applied to a surface including a material of interest, such as a biological agent, the neutralization composition encapsulates or otherwise adheres to the material of interest to neutralize the material, and then is cured. Curing of the composition forms a polymeric coating on the surface, and the neutralized composition is contained within or is adhered to the polymeric coating. In various embodiments, the polymeric coating can be peeled from the surface, optionally in a single piece, thereby removing the material of interest from the surface or reducing the amount of material that remains on the surface. Various embodiments of the composition and methods of using the composition will be described in more detail herein.

As used herein the term “neutralization” or “neutralize” are defined as causing a material of interest to be less capable of causing damage to an organism or present in a reduced amount on a previously contaminated surface so as to be less able to cause damage to an organism. The term “totally neutralize” or “total neutralization” are intended to mean that the material of interest is substantially undetectable on a previously contaminated surface or the material of interest is non-viable following a process as described herein or treatment with a composition as provided herein.

As used herein the term “resin” describes a solid or liquid organic monomer or polymer, optionally a polymerizable synthetic solid or liquid organic monomer or polymer. A resin may be an aqueous resin that is includes water or water soluble material as a solvent, or is an organic solvent resin that includes one or more non-aqueous organic solvents that are substantially insoluble in water.

Provided herein are neutralization compositions that are capable of encapsulating or bonding to a material of interest, optionally a material of interest that includes or is a biological agent. A neutralization composition includes at least a polymerizable resin and an active decontaminant. As will be described in greater detail below, the neutralization composition may further include one or more pH modifiers, pigments, suspension aids, rheology modifiers, solid sorbents, ion exchange resins, or reactive metal oxides. Additional or alternative additives may also be included, depending on the particular embodiment.

A resin optionally is or includes one or more polyurethanes, polyethylene terephalate (PET), silicones, natural or synthetic rubbers, or other materials. A resin is optionally a cross-linkable polymer resin, optionally the like of an unsaturated polyester resin or vinyl ester resin. The prepolymer resin optionally has a molecular weight at or between 400 and 10,000 Daltons.

A polyester prepolymer is optionally the result of a condensation reaction between unsaturated dibasic acids and/or anhydrides with one or more polyols. Vinyl ester resins are optionally the reaction product of an epoxy resin with a carboxylic acid having a single ethylenic unsaturation. Vinyl ester resins prepolymers are typically associated with terminal ethylenic unsaturations while polyester resin prepolymers typically include ethylenic unsaturations internal to the prepolymer backbone.

In particular embodiments, a resin is optionally vinyl ester resin (vinyl resin), optionally a water-soluble vinyl resin. The vinyl resin may be in the form of an emulsion including vinyl resin in water. Illustrative examples of a vinyl resin include alkyl polymers characterized by a vinyl group. Specific examples include polymers of styrene, isoprene, other vinyl alkenes, or derivatives thereof, among others. In some embodiments, the emulsion including the vinyl resin may have a boiling point of greater than about 100° C., and may include from about 20 wt % to about 60 wt % solids based on the total weight of the solution. In some particular embodiments, the emulsion includes from about 20 wt % to about 40 wt % solids, optionally 25 wt % to about 30 wt % solids, or even about 27 wt % solids. The emulsion may be made by emulsifying a vinyl resin in water. Alternatively, the vinyl resin may be a commercially available vinyl resin emulsion, or may include generic formulations of latex with or without other polymers illustratively styrene-butadiene rubber (SBR). Optionally a vinyl resin may be a polyvinyl alcohol (PVA) emulsion in water. Suitable commercially available vinyl resin emulsions include, but are not limited to, those available under the tradename FLOORPEEL™ including FLOORPEEL™ 4000, available from General Chemical Corporation (Brighton, Mich.), Vinnol E15/45 VL (Wacker Chemical Corporation, UCAR 451 IC (Arkema, Inc.), and STRIPCOAT TLC FREE™, available from BHI Energy (Weymouth, Mass.). Optionally, the emulsion forms a solid, strippable polymeric coating upon setting (e.g., curing or drying), as will be described in greater detail below.

Although embodiments described herein include a vinyl resin, it is contemplated that any other film-forming polymer or elastomer capable of forming a solid, strippable coating upon setting may be used in addition to or in place of the vinyl resin. For example, an elastomeric silicone (e.g. polysiloxane) may be used in the neutralization composition. In some aspects a polysiloxane peelable coating compositions is as described in JP2001089697A.

In particular aspects, a neutralization composition includes one or more active decontaminants. An active decontaminant may be, for example, a biocide. In some embodiments, the active decontaminant may be, for example, a protein, enzyme or chemical that is effective to nullify one or more materials of interest, optionally biological agents, chemical nerve agents, chemical blister agents, blood agents, and/or lung damaging agents. As used herein, “nullify” means to kill, render substantially inactive, or encapsulate.

In various embodiments, an active decontaminant may be a quaternary ammonium compound or mixture, a quaternary phosphonium compound or mixture, or other biocide. Optionally, a biocide is a quaternary ammonium compound or mixture, illustratively a benzalkonium chloride (BAC) such as benzyltrimethylammonium chloride, benzyltriethylammonium chloride, or others. Optionally, a biocide is a quaternary phosphonium compound, illustratively tetrakishydroxymethyl phosphonium sulfate (THPS).

Optionally, other active decontaminant(s) may be used illustratively triclosan (2,4,4′-trichloro-2′-hydroxydiphenyl ether), streptomycin, sodium phrithione (commercially available as Sodium Omadine® from Lonza), dichlorphen, methylene bisthiocyanate, and combinations thereof. Other suitable active decontaminants may include formaldehyde donors (e.g., paraformaldehyde, N-formals, O-formals), higher aldehyde donors (e.g., glutaraldehyde, ortho-phthalaldehyde), chlorine dioxide generators, and peroxygen generators.

In some embodiments, other active decontaminants may be employed depending on the particular material of interest. Without being bound by theory, it is believed that suitable active decontaminants act according to at least one of the following three mechanisms: denaturation of proteins; sulfhydral enzyme and amino acid oxidation or alkylation; and disruption or binding of access points in the cellular wall. The biocide reaches the target and executes one or more of the mechanisms of action, thereby nullifying the material of interest. It is further believed that incorporating the active decontaminant into the polymer matrix may control the release of the active decontaminant.

Without being bound by theory, it is believed that commercially available biocides may offer a number of advantages when used as an active decontaminant as provided herein, including but not limited to, broad spectrum efficacy against several classes of bacteria, activity at ppm levels, and prior manufacturer registration for use with the FDA and/or EPA. In various embodiments, the biocide may include THPS.

In various embodiments, the active decontaminant may include a blended biocide composition, such as a blend of triclosan, BAC, and THPS. For example, the active decontaminant may include from greater than 0 wt % up to about 6.6 wt % triclosan, from greater than 0 wt % up to about 2.5 wt % BAC and from greater than 0 wt % up to about 3.0 wt % THPS based on a total weight of the active decontaminant. In some embodiments, the active decontaminant may include from about 0.1 wt % to about 1 wt % triclosan, from about 0.1 wt % to about 2.5 wt % BAC, and from about 0.1 wt % to about 3.0 wt % THPS based on a total weight of the active decontaminant. In one particular embodiment, the active decontaminant may include about 0.5 wt % triclosan, about 0.5 wt % BAC, and about 1.5 wt % THPS based on a total weight of the active decontaminant.

The active decontaminant may be present in any suitable amount. In various embodiments, the neutralization composition includes from about 1 wt % to about 15 wt % of the active decontaminant based on a total weight of the neutralization composition. For example, the neutralization composition may include from about 1 wt % to about 15 wt % of the active decontaminant, from about 1 wt % to about 14 wt % of the active decontaminant, from about 1 wt % to about 13 wt % of the active decontaminant, from about 1 wt % to about 12 wt % of the active decontaminant, from about 2 wt % to about 15 wt % of the active decontaminant, or from about 2 wt % to about 14 wt % of the active decontaminant based on a total weight of the neutralization composition. It is contemplated that in some embodiments, higher concentrations of active decontaminant may be included, such as when the neutralization composition will be diluted prior to use.

More than one active decontaminant may be present in the neutralization composition. Optionally 1, 2, 3, 4, 5, or more active decontaminants may be present. Optionally at least two decontaminants are present, optionally with differing functional activities. Optionally at least three decontaminants are present, optionally with differing functional activities.

In various embodiments, the neutralization composition may include a pH modifier to adjust a pH of the neutralization composition. Suitable pH modifiers may include, by way of example and not limitation, sodium carbonate, calcium carbonate, sodium bicarbonate, sodium tetraborate hexahydrate (i.e., Borax), sodium hydroxide, and combinations thereof. In various embodiments, the pH modifier may be added in any suitable amount to bring the pH of the neutralization composition to a pH of greater than about 6.0. For example, the pH modifier may bring the neutralization composition to a pH of from about 8.0 to about 9.0. In some particular embodiments, the neutralization composition has a pH of about 8.5. Without being bound by theory, it is believed that the pH of about 8.5 may result in the apparent concentrations of the active decontaminant, resulting in a greater efficacy of the neutralization composition.

Optionally, the neutralization composition may include one or more pigments to impart a color to, or alter a color of, the neutralization composition. For example, a pigment may be included in the neutralization composition such that when the composition forms a coating on a surface, a user can readily identify the coating on the surface and confirm removal of the coating from the surface. Any one of a variety of suitable pigments may be employed, provided they do not significantly adversely impact the efficacy of the active decontaminant. In some embodiments, the pigment may be titanium dioxide (TiO₂), iron oxide, carbon black, or any pigment that will not appreciably inhibit cure or affect neutralization. When included in the neutralization composition, the pigment may be present in an amount of from about 0 wt % to about 25 wt %, or any value or range therebetween.

The neutralization composition may further include one or more optional suspension aids. The suspension aid may enhance the stability of the particles in the neutralization composition to prevent particles from agglomerating and settling or floating out of the composition. Any suitable suspension aid may be used, such as, for example, clays, cellulosic polysaccharides, synthetic hydrocarbon polymers, biopolymer polysaccharides, acrylic copolymers, or the like. In some embodiments, kaolin clay may be used as a suspension aid. When included in the neutralization composition, the suspension aid may be present in an amount of from about 0 wt % to about 10 wt % or any value or range therebetween, optionally 0.1 wt % to 10 wt %.

In various embodiments, an optional rheology modifier is further included in the neutralization composition. A rheology modifier is a compound or compounds that act to change the viscosity of the dispersion, typically by increasing the viscosity. In some embodiments, the suspension aid may additionally function as a rheology modifier. In various embodiments, the rheology modifier is a water-based rheology modifier, such as a hydrophobically-modified ethoxylate urethane (HEUR). However, it is contemplated that other rheology modifiers may be employed, depending on the particular embodiment. In embodiments that include a rheology modifier, the neutralization composition may include from about 0 wt % to about 25 wt % of the rheology modifier, based on a total weight of the neutralization composition.

The neutralization composition may further include an optional solid sorbent. In embodiments in which a solid sorbent is included, the solid sorbent may provide greater surface area for interaction with the material of interest, and may act as a reservoir for the reactants in the neutralization composition. In various embodiments, the solid sorbent is in the form of a nanocrystal or fine powder. It is contemplated that the solid sorbent may be present in other forms, although it is believed that the use of nanocrystals or fine particles may facilitate mixing into the polymer matrix and/or provide additional enhancements to the surface area. The solid sorbent may be, for example, fuller's earth, silica gel, amorphous silicates, or the like. Other solid sorbents may be employed, such as charcoal or other known solid sorbents. In embodiments that include a solid sorbent, the neutralization composition may include from about 1 wt % to about 25 wt % of the solid sorbent, based on a total weight of polymer solids in the neutralization composition.

Some embodiments of the neutralization composition may further include an optional reactive metal oxide. When included, the reactive metal oxide may be used to mitigate the toxicity of the material of interest. In various embodiments, the reactive metal oxide may be in the form of a nanocrystalline metal oxide. Without being bound by theory, it is believed that the reactive metal oxide may work with the solid sorbent, when both are included in the neutralization composition, to react with and retain the material of interest, but not degrade the polymeric substrate of the neutralization composition. For example, the material of interest may be absorbed into the polymer to form a solid solution and any toxic by-products may continue to migrate within the polymer matrix. Accordingly, the reactive metal oxide and/or the solid sorbent may react with and/or adsorb the by-product, rendering the by-product non-hazardous.

The metal oxide may be, for example, titanium dioxide, magnesium oxide, nanocrystalline lime (CaO), aluminum oxide, or the like. In some embodiments, the metal oxide may include a halogen adduct (e.g., Cl₂ or Br₂). In embodiments that include a metal oxide, the neutralization composition may include from about 0 wt % to about 10 wt % of the metal oxide, based on a total weight of polymer solids in the neutralization composition.

As an alternative to, or in addition to, a metal oxide, some embodiments may include one or more other materials to aid in the neutralization of toxic materials that could create vapor hazards. For example, metal ion catalysts (e.g., copper (II)), enzymes for decontamination and biodegradation, catalytic oxidation agents such as N-cyclohexyl-2-pyrrolidone, solid polymer matrices, and/or ion exchange resins may be included. Ion exchange resins may be, for example, acidic cation-exchange resins or basic anion-exchange resins.

To prepare the neutralization composition, the active decontaminant and any additives (including, but not limited to, pH modifiers, pigments, suspension aids, rheology modifiers, solid sorbents, ion exchange resins or reactive metal oxides) may be added to the vinyl resin and mixed thoroughly. Optionally a suspension of vinyl resin is made in a solvent such as water or other suitable solvent. The decontaminants, modifiers (e.g., rheology modifier, pigment, sorbents, etc.), and other additives may be added to complete the dilution to the correct percentage of polymer solids. This may be directly applied. Optionally, actives that require specific chemistry may be added immediately before application.

When used, the neutralization composition may be applied as a coating to a surface including a material of interest. The surface may be, for example, a hard, non-porous surface, such as a glass, metal surface (e.g., stainless steel), a painted surface, concrete surface, or other. Other surfaces are contemplated, including, but not limited to, polymeric surfaces (e.g., plastics), flexible surfaces, porous surfaces, fibrous surfaces, and fabric surfaces.

The material of interest may be, for example, a biological agent (naturally or non-naturally occurring organism or component thereof), a chemical nerve agent, a chemical blister agent, a blood agent (i.e, an agent that can exist in blood, replicate in blood, infect a component of blood, alter the function of a component of blood, structurally alter a component of blood), a lung damage agent, toxic industrial chemical, and/or a toxic industrial material.

Illustrative examples of toxic industrial chemicals or toxic industrial material include but are not limited to benzene acrylamide, chlorine, hydrogen chloride, phosgene, aldrin, dieldrin, endrin, lindane, heptachlor, piperonyl butoxide, pentachlorophenol, hexachlorobenzene, calcium cyanide, methyl bromide, phosphine, methylmercury acetate, methylmercury cyanide, petroleum wastes, among others.

A biological agent is optionally a bacteria, a virus, fungi, protozoa, worm, insect, or protein (optionally an infectious protein). Optionally, a biological agent is a bacterial organism. A bacterial organism is optionally one or more of Staphylococcus aureus, Bacillus anthracis, Pseudomonas aeruginosa, Acinetobcter baumannii, Bacillus subtilis, Bacillus globigii, Yersinia pestis, Francisella tularensis, Br. melitensis, Burkholderia pseudomallei, C. botulinum, or Burkholderia mallei. A biological agent is optionally a bacterial spore, optionally a spore of Bacillus anthracis or Bacillus thuringiensis var. Kurstaki.

A biological agent is optionally a virus. Illustrative examples of a virus include but are not limited to human immunodeficiency virus (HIV), norovirus, varicella virus, variola virus, rabies virus, papillomavirus, cytomegalovirus, among others. Other illustrative examples include Filoviridae viruses (e.g. Marburg virus and Ebola virus), Arenaviridae viruses (e.g. Lassa virus and Machupo virus), alphaviruses (e.g. Venezuelan equine encephalitis, eastern equine encephalitis, western equine encephalitis), Nipah virus, Hanta virus, H1N1 or other influenza virus, among others.

When the material of interest is a biological agent, it may be, for example, a category A or a category B biological agent, such as Bacillus anthracis (anthrax), Clostridium botulinum (botulism), Yersinia pestis (plague), Variola major (smallpox) or other pox viruses, Francisella tularensis (tularemia), viral hemorrhagic fever viruses, arenaviruses, bunyaviruses, flaviviruses (including Dengue), filoviruses (including Ebola and Marburg), Burkholderia pseudomallei (melioidosis), Coxiella burnetii (Q fever), Brucella species, ricin, staphylococcus enterotoxin B, bacteria (including E. coli, salmonella, Listeria monocytogenes, Hepatitis A, mosquito-borne encephalitis viruses, and the like. In some embodiments, the material of interest may be a simulant of a biological agent, a chemical nerve agent, a chemical blister agent, a blood agent, a lung damage agent, and/or a toxic industrial chemical. In one particular embodiment, the material of interest may be Bacillus anthracis (B. anthracis) or Bacillus atrophaeus (B. atrophaeus), a simulant of B. anthracis, or a spore thereof.

The neutralization composition may be applied to the surface as an aqueous (or other liquid) composition using any suitable coating method. For example, the neutralization composition may be applied by spraying, rolling, or the like. In some particular embodiments, the neutralization composition is applied by spraying the neutralization composition onto the surface. As briefly described above, in various embodiments, the neutralization composition optionally has a viscosity that enables it to be applied as a coating on a sloped or even vertical or overhead (e.g. hanging) surface such that the neutralization composition will sufficiently polymerize or dry so and to continue to coat the surface.

Optionally, the neutralization composition is applied to the surface to substantially completely coat the surface, with substantially no holes, gaps, or interruptions in the coating. The neutralization composition may be applied at any suitable thickness, although in various embodiments, the neutralization composition is applied at a thickness sufficient to produce a polymeric coating having a thickness of from about 100 μm to about 500 μm after curing. Although thinner or thicker coatings may be applied, the coating should be thick enough to exhibit the appropriate properties (including strength and elasticity) to enable it to be completely removable by peeling and completely neutralize the material of interest while being thin enough to not result in wasted material or adversely impact cure time.

After the neutralization composition is applied to the surface, the neutralization composition encapsulates the material of interest effective to neutralize the material of interest. In particular, it is believed that the neutralization composition may create an occlusive seal between the surface and material of interest and the environment, which is effective to encapsulate the material of interest from the environment. For example, the active decontaminant in the neutralization composition may flow around and coat or otherwise adhere to the particles of the material of interest that are present on the surface. While the material of interest is encapsulated, the active decontaminant works to further neutralize the material of interest. As described in greater detail above, the mechanism of neutralization of the material of interest may vary depending on the particular active decontaminant employed. In embodiments including one or more additives in the neutralization composition, it is further contemplated that by-products of the neutralization of the material of interest may further be broken down or otherwise rendered non-toxic by one or more of the additives, optionally as described above.

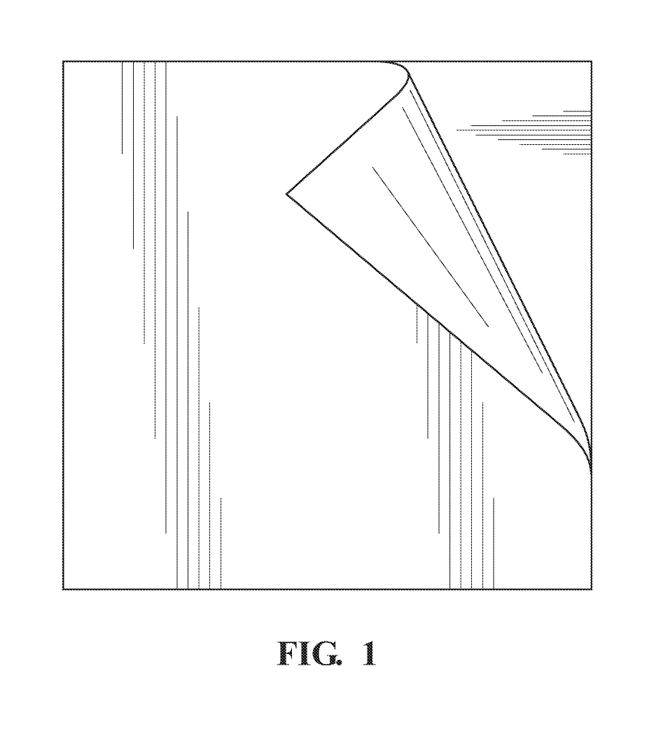

After the material of interest is encapsulated, the neutralization composition is cured, thereby forming a polymeric coating on the surface, as shown in FIG. 1. Curing may be conducted at room temperature, or in some embodiments, the coating may be exposed to light and/or heat in order to cure the neutralization composition into the polymeric coating. In various embodiments, the neutralization composition is cured within a time of about 2 hours or less from the time that the neutralization composition is applied as a coating. Longer or shorter cure times are contemplated, depending on the particular film-forming polymer or elastomer that is employed. However, in some embodiments, a cure time of about two hours or less may be desired in order to enable efficient removal of the material of interest from the surface. As the neutralization composition cures, the particles of the material of interest adhere to or become entrapped in the polymeric coating.

After the neutralization composition has cured into a polymeric coating on the surface, the polymeric coating is optionally peeled from the surface as illustrated in FIG. 1. Removal of the polymeric coating may be performed soon after or immediately after curing is complete, such as when the surface is to be used, or the removal may be conducted some time later. For example, the polymeric coating may be left in place while work is conducted around the surface without concern of cross-contamination by the material of interest. In various embodiments, the polymeric coating may be peeled off in a single piece, or in several large pieces, without flaking. Accordingly, the polymeric coating, along with the material of interest encapsulated therein, may be completely removed from the surface by peeling it from the surface. In embodiments in which the neutralization composition includes a pigment, as one example, confirmation that the removal of the polymeric coating is complete may be visual, such as by observing that there is no colored polymer coating remaining on the surface.

After removal from the surface, the polymer coating may be rolled or folded upon itself to keep the material of interest isolated from the environment. In such cases, even if the material of interest has not been completely neutralized by the active decontaminant, the material of interest is prevented from further contaminating the environment or spreading through the environment. Moreover, in the event that the material of interest has not been completely neutralized, neutralization of the material of interest may continue after the polymeric coating is peeled from the surface.

Also provided is a sampling device that employs as a portion of the device or as the device itself, a neutralization composition as provided herein. In some embodiments of a sampling device, the neutralization composition may be applied to one or more surfaces of the device, or side, of a sheet material. The sheet material may be formed from, for example, a relatively rigid material, optionally a polymerized or otherwise rigid polymer. Illustrative polymers may include polycarbonate, polyvinylidene fluoride (PVdF), polystyrene, acrylic, nylon, polyethylene, polypropylene, polyvinyl chloride, among others. The neutralization composition may be formulated as an adhesive composition coated onto a surface of the sheet material.

After application to a sheet material, the neutralization composition may dry for immediate or later use. Optionally, to activate a neutralization composition when employed in sampling device, the neutralization composition may be activated such as by moistening the area with water or other suitable activation agent. For example, sterile water may be applied to the surface using an applicator. Alternatively, a protective strip may be placed over the neutralization composition to maintain tackiness of the film on the sheet material. In such embodiments, the protective strip may be removed prior to using the sampling device in order to expose the film formed from the neutralization composition.

Once activated, the neutralization composition may adhere or absorb materials of interest in the air or on a surface when the neutralization composition is exposed to the material of interest. For example, the sampling device may be applied to the surface with the side including the neutralization composition in contact with the surface and the material of interest may adhere to the neutralization composition. Alternatively, such as in embodiments in which the material of interest is present as a contaminant in the air, the sampling device may be exposed to the air for time sufficient to enable the material of interest to adhere to the neutralization composition.

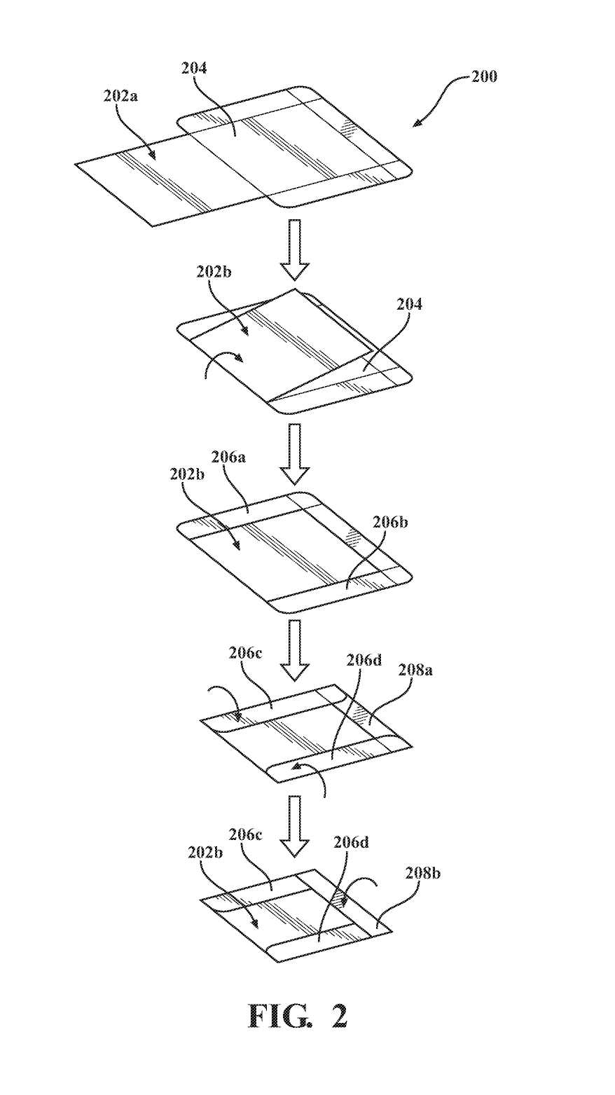

Optionally, a sampling device may be foldable. The sheet material including the neutralization composition may be folded upon itself optionally to seal the material of interest inside following exposure of the neutralization composition to the material of interest. FIG. 2 schematically depicts a sampling device 200 in accordance with various embodiments in which the device is foldable. In FIG. 2, the neutralization composition may be applied as a film to the internal panel 202a of the sheet material. The neutralization composition may additionally or alternatively be applied as a film to the internal panel 204 of the sheet material. After exposure to the material of interest, the internal panel 202a may be folded up and into contact with internal panel 204, adhering the internal panels 202a and 204 to one another while exposing panel 202b, which is on the opposing side of the sheet material from the internal panel 202a. Next, the side panels 206a and 206b may be folded in and into contact with the panel 202b. When the side panels 206a and 206b are folded in, side panels 206c and 206d, which are on the opposing side of the sheet material from side panels 206a and 206b respectively, can be seen. Finally, the top panel 208a may be folded down into contact with the panel 202b and side panels 206c and 206d. Thus, as shown in FIG. 2, when folded, the surface including the neutralization composition is completely sealed and only the opposing side of the sheet material is exposed to the environment.

The neutralization composition may then be sealed into a packaging material, such as an envelope formed from biaxially-oriented polyethylene terephthalate (BOPET; commercially available as MYLAR®) for transportation to a testing or other analysis facility. However, it is contemplated that in some embodiments, testing or at least partial processing of the sampling device may be conducted at the same location as collection.

For analysis, the neutralization composition alone or the sampling device as a whole may be dissolved in an organic solvent or aqueous solvent system. In some embodiments, the solvent may be simply water or a water-based solution. For example, the neutralization composition or sampling device may be placed in water and dissolved with vortex and/or centrifugation. Other solvents may be used, depending on the particular materials employed for the neutralization composition. Filtration, recovery, and other extraction techniques may be employed to retain and/or concentrate the material(s) of interest as analytical samples.

Following obtaining analytical samples of the material of interest, one or more assays may be conducted to identify the material of interest and/or confirm neutralization of the material of interest. For example, any one or more know chromatographic techniques, spectroscopic techniques, or other analytical chemistry techniques may be employed, including, but not limited to, gas chromatography (GC), liquid chromatography (LP or HPLC), mass spectrometry, x-tray diffraction, atomic absorption, scanning electron microscopy, or the like. Alternatively or in addition, DNA assays, direct spore counting, or the like may be employed. As a result of the analysis, decontamination can be confirmed, causes of contamination can be identified, and other decontamination processes may be implemented.

Various aspects of the present invention are illustrated by the following non-limiting examples. The examples are for illustrative purposes and are not a limitation on any practice of the present invention. It will be understood that variations and modifications can be made without departing from the spirit and scope of the invention. Reagents illustrated herein are commercially available, and a person of ordinary skill in the art readily understands where such reagents may be obtained.

### EXAMPLES

The ability of a liquid and/or polymeric neutralization composition to remove and kill bacterial endospores of Bacillus atrophaeus dried onto glass carriers was ascertained substantially in accord with ASTM method E2414-05 “Standard Test Method for Quantitative Sporicidal Three-Step Method (TSM) to Determine Sporicidal Efficacy of Liquids, Liquid Sprays, and Vapor or Gases on Contaminated Carrier Surfaces” with minor modifications. Testing was performed using 2.5 cm×2.5 cm microscope slide glass as a substrate. A sample preparation tube was a 50 ml conical centrifuge tube instead of a standard 1.5 ml microcentrifuge tube.

Briefly, individual glass coverslips (25 mm×25 mm) are spiked with an aliquot (0.1 ml) Bacillus atrophaeus spore (Raven Biological Laboratories, Inc.) suspension of about 1.7×10¹⁰ spores/ml, spread evenly over the surface and allowed to dry overnight. A 3 mm edge was left un-spiked to ensure the spiked area could be completely covered with the neutralization composition under test (i.e. no fugitive spores were contained in the side edge or back of the slide. Prior to inoculation, the glass slides were pre-sterilized and pre-cleaned using ethanol to remove fingerprints or other contaminants and the coupon was allowed to dry.

A series of neutralization compositions are formed using the vinyl resin sold as FLOORPEEL™ 4000 (General Chemical Corporation (Brighton, Mich.) (20 wt % in water) spiked with various amounts of the active decontaminant tetrakishydroxymethyl phosphonium sulfate (THPS), triclosan, or benzalkonium chloride (BAC) in various combinations with the final amounts of active decontaminant being 1 wt %, 2 wt % or 4 wt %. The final pH of the neutralization composition is adjusted to about 8.3 using Na₂CO₃. Formulations of neutralization compositions are tested within one hour of formation.

Small glass carriers were coated onto the glass substrates using a disposable coating apparatus comprising a steel base to which two glass sheets were glued on either side of the glass carrier. The carrier to be coated was placed in a channel created by the set of neighboring plates to create a single level plane. To coat the carrier, the drawdown bar was dragged across the composite glass surface and then the coated glass carrier was removed and allowed to dry. For these coatings a drawdown bar with a 12 mil gap was used resulting in a dry thickness of approximately 6 mils. The polymer emulsions were allowed to dry for 120 minutes.

After 120 min of contact time, each of the dried neutralization compositions were peeled off the glass substrates with sterile forceps and any remaining spores on the glass were assayed for both number and cultivability. The test substrates are placed in individual 50 ml conical tubes (1 per tube) and sufficient volume of cold growth media (i.e., 20 ml) is added to completely cover the material. The tubes were then sonicated for 10 min and vortexed for 2 minutes. Alternatively, the spores were scraped from the surface of the glass substrates using a policeman. Spores recovered following removal were counted directly by phase contrast microscopy using a Petroff-Hausser counting chamber and then plated onto TSA plates over a series of 10-fold serial dilutions to determine the number of cultivable spores as colony forming units (CFU) by outgrowth. Plates are incubated for 24 hours at 37° C., the number of colonies counted, and the plates incubated and recounted at 48 hours. The colony counts were converted to log₁₀ and reductions are reported as both log reduction and percent kill. Results are illustrated in Table 1.

TABLE 1

| | Formulation | | |
|---|---|---|---|
| | 1 wt % | 2 wt % | 4 wt % |
| | biocide | biocide | biocide |
| Initial spore “seeding” (CFU) | 1.7 × 10⁹ | 1.7 × 10⁹ | 1.7 × 10⁹ |
| Post-treatment recovery (CFU) | 2.53 × 10⁷ | <133 | <133 |
| Live spore reduction (CFU) | 6.71 × 10¹ | >1.28 × 10⁷ | >1.28 × 10⁷ |
| log₁₀ reduction | 1.83 | >7.11 | >7.11 |

As a negative control, a neutralization composition without any active decontaminant included was also tested. Results showed that greater than 93% of the seeded spores were removed by adhering to or being embedded into the cured neutralization composition. The presence of the biocide in a neutralization composition, particularly at 2 wt % and 4 wt % dramatically reduced the viability of any spores remaining on the glass slides such that substantially no spore growth was found in these samples following peeling of the neutralization composition.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method of neutralizing a material of interest, comprising:
applying a neutralization composition comprising a resin and an active decontaminant to a surface having the material of interest disposed thereon;
encapsulating the material of interest with the neutralization composition;
curing the neutralization composition on the surface, thereby forming a polymeric coating on the surface; and
peeling the polymeric coating from the surface so as to remove the material of interest from the surface.

2. The method of claim 1, wherein the material of interest is selected from the group consisting of a biological agent, a chemical nerve agent, a chemical blister agent, a blood agent, a lung damaging agent, and a toxic industrial chemical (TIC) or toxic industrial material (TIM).

3. The method of claim 1, wherein the material of interest is a biological agent comprising a bacteria, a bacterial spore, or a virus.

4. The method of claim 1, wherein the active decontaminant comprises a chloride or sulfide compound.

5. The method of claim 1, wherein applying the neutralization composition comprises applying the neutralization composition as an aqueous composition.

6. The method of claim 1, wherein applying the neutralization composition comprises spraying the neutralization composition onto the surface.

7. The method of claim 1, wherein the surface comprises a porous surface or a non-porous surface.

8. The method of claim 1, wherein the surface comprises a painted surface, a plastic surface, or a glass surface.

9. A neutralization composition comprising:
a resin; and
an active decontaminant comprising a quaternary ammonium or quaternary phosphonium compound.

10. The neutralization composition of claim 9, wherein the active decontaminant comprises tetrakishydroxymethyl phosphonium sulfate (THPS).

11. The neutralization composition of claim 10, wherein the pH of the neutralization composition is greater than 6.

12. The neutralization composition of claim 9, further comprising a pH modifier in an amount effective to result in a pH of the neutralization composition of from about 8 to about 9.

13. The neutralization composition of claim 12, wherein the pH modifier is selected from the group consisting of sodium carbonate, calcium carbonate, sodium bicarbonate, sodium tetraborate hexahydrate, sodium hydroxide, and combinations thereof.

14. The neutralization composition of claim 1, wherein the active decontaminant is present in an amount of from about 1 wt % to about 15 wt % based on a total weight of the neutralization composition.

15. The neutralization composition of claim 9, further comprising at least one of a pigment, a suspension aid, or a rheology modifier.

16. The neutralization composition of claim 9, further comprising at least one of a solid sorbent, an ion exchange resin, or a reactive metal oxide.

17. A method of neutralizing a biological agent, comprising:
spraying a neutralization composition comprising a vinyl resin and an active decontaminant onto a substantially non-porous surface having the biological agent disposed thereon;
encapsulating the biological agent with the neutralization composition;
curing or drying the neutralization composition on the non-porous surface thereby forming a solid polymeric coating on the non-porous surface; and
peeling the polymeric coating from the non-porous surface, wherein peeling the polymeric coating from the non-porous surface is effective to neutralize the biological agent.

18. The method of claim 17, wherein the decontaminant comprises a quaternary ammonium or quaternary phosphonium.

19. The method of claim 18, wherein the active decontaminant is present in an amount of from about 1 wt % to about 15 wt % based on a total weight of the neutralization composition.

20. The method of claim 18, wherein the polymeric coating has a thickness of from about 100 μm to about 500 μm.
